(19) United States
(12) Patent Application Publication
(10) Pub. No.: US 2018/0008389 A1
(43) Pub. Date: Jan. 11, 2018

(54) Mouth Appliance Devices, Systems, and Methods

(71) Applicant: MMDA, LLC, Huntsville, AL (US)

(72) Inventors: David J. Allen, Huntsville, AL (US); Wade C. Patterson, Huntsville, AL (US); Tracey Greene, Huntsville, AL (US); Wes Schilling, Starkville, MS (US); Jasmine D. Hendrix, Starkville, MS (US)

(21) Appl. No.: 15/701,165

(22) Filed: Sep. 11, 2017

Related U.S. Application Data
(63) Continuation-in-part of application No. 15/207,253, filed on Jul. 11, 2016.

(51) Int. Cl. A61C 19/06; A61J 7/00; B29C 51/10

(52) U.S. Cl. CPC A61C 19/063; B29C 51/10; A61C 19/066; A61J 7/0092

(57) ABSTRACT

A tray appliance of the present disclosure has a first dissolvable sheet and a first substance formed within a second dissolvable sheet. The first dissolvable sheet is laid on the second dissolvable sheet and is formed into a first dissolvable negative impression of a person's teeth, gingival tissue, or other soft tissue, such that when first dissolvable negative impression is worn by a person, the first dissolvable negative impression dissolves and releases the first substance into the person's saliva, teeth, gingival tissue, or other soft tissue.

### CROSS REFERENCE TO RELATED APPLICATION

This patent application is a continuation-in-part and claims priority to U.S. patent application Ser. No. 15/207,253 entitled Mouth Appliance Devices, Systems, and Methods and filed on Aug. 3, 2016, which claims priority to U.S. provisional patent application Ser. No. 62/190,991 entitled Teeth Tray Systems and Methods filed on Jul. 10, 2016, which are incorporated herein by reference it their entirety.

### BACKGROUND

A dental impression is a negative imprint of one's teeth, gingival tissue, or other soft tissue. Typically, it is made of a substance that is semi-solid or liquid, e.g., alginate. This substance is placed in a dental tray, inserted into a patient's mouth, and pressed against the patient's teeth. The substance hardens, and the resulting impression may then be used to create a positive impression of the patient's teeth, gingival tissue, or any soft tissue in the mouth.

The positive impression of the patient's teeth is then used to create a custom tray appliance. A custom tray appliance is made of thin, yet durable material, and it is a negative impression of the patient's teeth. The thin material is placed over the positive impression and placed in a vacuum heater.

Alternatively, the customized tray appliance can be created digitally. In this regard, a digital scan is taken of the patient's teeth, gingival tissue, or other soft tissue. A computing device, accompanied by a 3D printer, creates a customized tray appliance.

Customized mouth appliances have many uses. For example, a subset of custom mouth appliances is teeth bleaching trays. In such an example, dental mouth appliances are made for both the upper and lower teeth and bleaching substances are placed in the dental mouth appliances. The custom mouth appliances are fitted to the patient's teeth such that the bleaching substance contacts the patient's teeth over a prescribed period of time thereby allegedly whitening the patient's teeth.

### BRIEF DESCRIPTION OF THE FIGURES

FIG. 1 is a bottom plan view of an impression of one's teeth.

FIG. 2 is a mold made from the impression depicted in FIG. 1.

FIG. 3 is a vacuum suction device for making dental trays.

FIG. 4 is a sheet of a mixture of methylcellulose, propylene glycol and xanthan gum for fabricating custom tray appliances.

FIG. 5 is a mold placed in granules in a section of the vacuum suction device.

FIG. 6 is the vacuum suction device of FIG. 3 in a closed position, heating a methylcellulose, propylene glycol, and xanthan gum sheet as shown in FIG. 4, and vacuum suctioning the sheet over the model in the granules of FIG. 5.

FIG. 7 is a tray appliance formed over the model in the granules after the heating and suctioning as shown in FIG. 6.

FIG. 8 is a mold of FIG. 2 with a tray appliance formed thereon, and the excess EVA trimmed away.

FIG. 9 is a tray appliance resulting from the mold shown in FIG. 8, which may extend onto the gingival tissue or other soft tissue.

FIG. 10 is an exemplary dissolvable sheet for making tray appliances such as is shown FIG. 9

FIG. 11 is another exemplary dissolvable sheet for making methylcellulose, propylene glycol, and xanthan gum tray appliances such as is shown in FIG. 9.

FIG. 12 is an exemplary tray appliance having a mesh lining in accordance with an embodiment of the present disclosure.

FIG. 13A is an exemplary layered dissolvable sheet for making tray appliances such as is shown in FIG. 9.

FIG. 13B is a cross sectional view of the layered dissolvable sheet as depicted in FIG. 12A.

FIG. 13C is another exemplary cross section view of a bi-layered dissolvable sheet for making tray appliances as depicted in FIG. 9.

FIG. 14 is a flowchart of an exemplary method in accordance with an embodiment of the present disclosure.

### BRIEF DESCRIPTION OF THE DISCLOSURE

The present disclosure describes customized mouth appliance devices, systems, and methods for making same. The customized mouth appliances of the present disclosure comprise a dissolvable mouth appliance that may be treated for varying applications.

In one embodiment, the customizable, dissolvable tray appliance is treated with pigments so that the mouth appliance may be worn for entertainment purposes. In another embodiment, the mouth appliance may be made of a dissolvable material that is injected with vitamins, medicine, or other orally delivered substances such that when the mouth appliance dissolves, the substance is delivered to a person's body who is wearing the mouth appliance.

In one embodiment, the mouth appliance is made of one or more layered dissolvable sheets, and in between layers of dissolvable sheets that don't comprise substances are layers of dissolvable sheets that do comprise substance, e.g., vitamins, medicine, or the like. In such an embodiment, the substances may be selectively delivered over a period of time to the wearer of the mouth appliance depending upon the where the layer is in the mouth appliance.

In another embodiment, a mesh may be inserted into the mouth appliance prior to insertion of the mouth appliance into the wearer's mouth. In such an embodiment, the mouth appliance and/or the mesh may be dissolvable, and the mesh may contain a substance for delivery to the wearer, e.g., vitamins, medicine, or the like. Note that the term “mouth appliance” refers to any type of device, including a teeth tray, which may be made for insertion into a person's mouth. Throughout the remainder of this document, the term “teeth tray” or “tray” will refer to as an exemplary mouth appliance for use in accordance with the present disclosure.

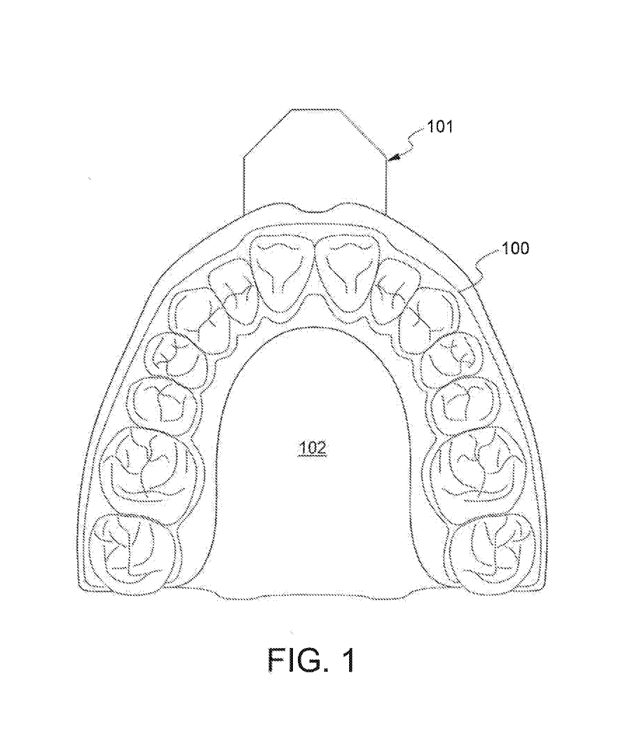

FIG. 1 depicts a dental tray 101 that is adapted to receive impression material 101. The dental tray 101 is inserted into a patient's mouth (not shown), and the impression material 100 is pressed upward or downward on the patient's teeth, gingival tissue, or other soft tissue so that a mold 102 of the patient's teeth, gingival tissue, or other soft tissue is captured in the impression material 101.

Note that in another embodiment, a digital image of the patient's teeth, gingival tissue, or other soft tissue may be captured by a specialized camera that captures images in three dimensions. Once the images are captured, the images may be transmitted to a 3D printer, and a mold of the patient's teeth, gingival tissue, and other soft tissue is created by the 3D printer.

Note that the dental tray 101 may be made of any type of solid, inflexible material known in the art or future-developed. As an example, the dental tray 101 may be made of metal, composite metal, or hard plastic.

Note that the impression material may be, for example, sodium alginate, polyether and silicones, or polyvinyl siloxane. The mold thus captures a negative impression of the patient's teeth, gingival tissues, and other soft tissues.

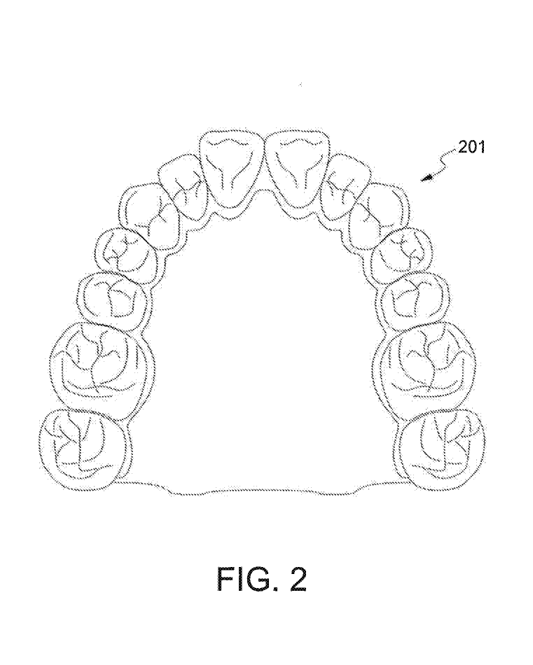

The impression material 101 hardens, and a negative mold of the person's teeth may then be cast from the hardened impression. In this regard, a hardening material is poured into the impression, and a mold 201 as shown in FIG. 2 is created from the impression 102 (FIG. 1).

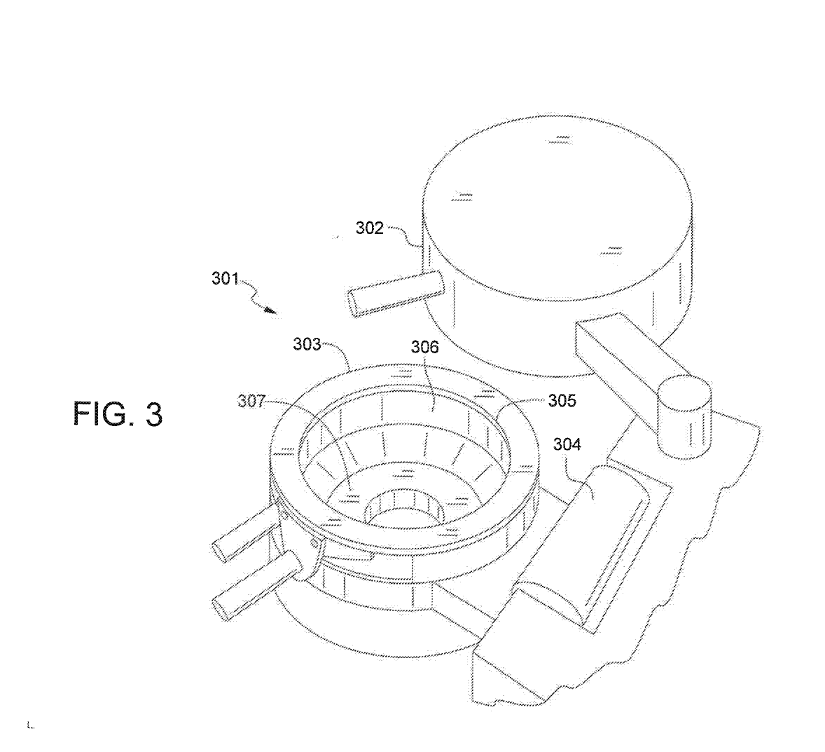

Once a mold is made of a patient's teeth, a teeth tray may be made using a device, which is now described with reference to FIGS. 3-8.

In this regard, a tray-making device 301 is depicted in FIG. 3. The device 301 comprises an upper member 302 and a lower member 303 that are aligned and closeably coupled via a hinge 304. In operation, the upper member 302 is hingedly rotated and closed over the lower member 303, which is shown further herein.

The lower member 303 comprises an aperture 305 that forms a cavity. The cavity is defined by a contiguous side wall 306 and floor 307. As will be described further, the mold and a thermoplastic sheet are inserted in the cavity relative to one another, and the upper member is brought downward to removeably couple to the lower member 303.

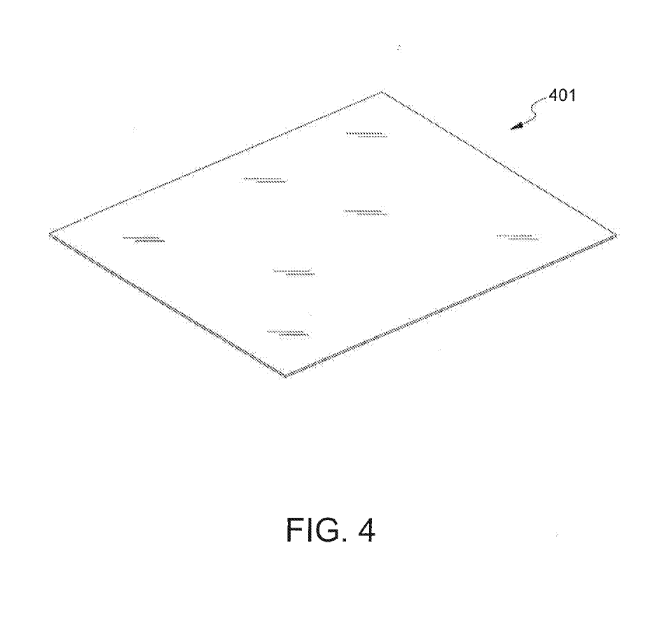

Further, FIG. 4 depicts a thermoplastic sheet 401 that is used in the process of making the teeth tray using the device 301. The thermoplastic sheet 401 is made of material that is safe for human consumption. Further, the material from which the thermoplastic sheet 401 is made contains a dissolvable component material.

In one embodiment, a thermoplastic sheet 401 is made from TIC Gums TICACEL® HV Powder: Methylcellulose; TIC Gums PreHydrated® Ticaxan® Xanthan Powder: Xanthan Gum; Essential Depot: Propylene Glycol USP-Kosher Food Grade; and distilled water. This is sometimes referred to herein as a base mixtuxture. The base mixture provides the sheet 401 its basic semi-hard, stiffness, and dissolvable qualities. Note that these are merely exemplary materials, and other materials may be used to make the thermoplastic sheet 401 in other embodiments.

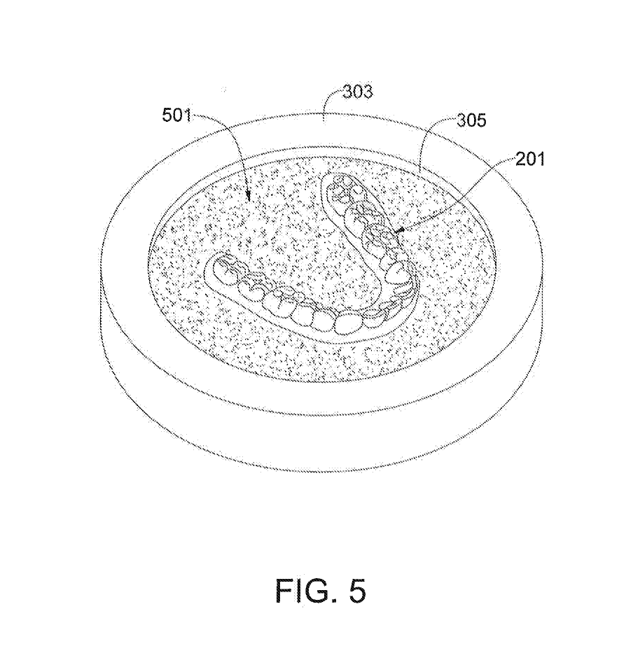

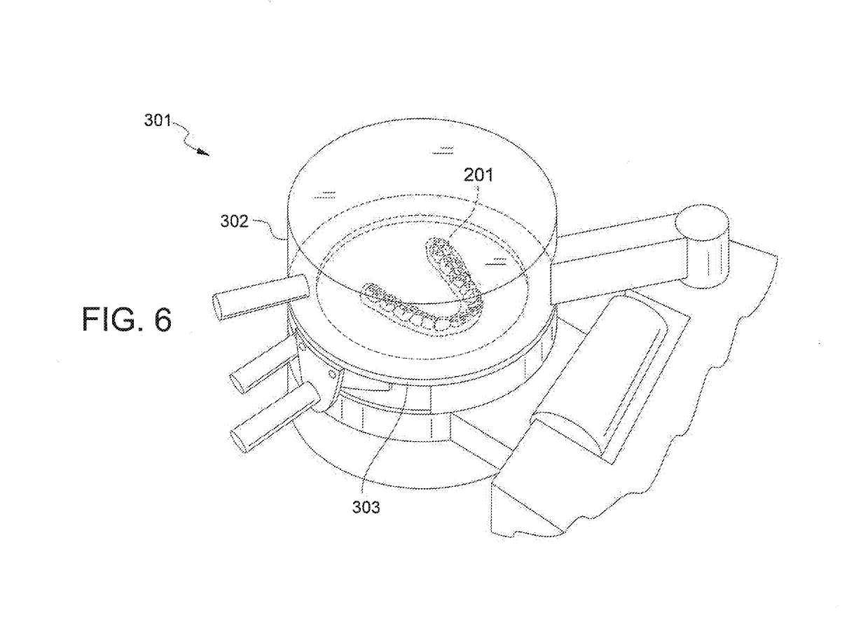

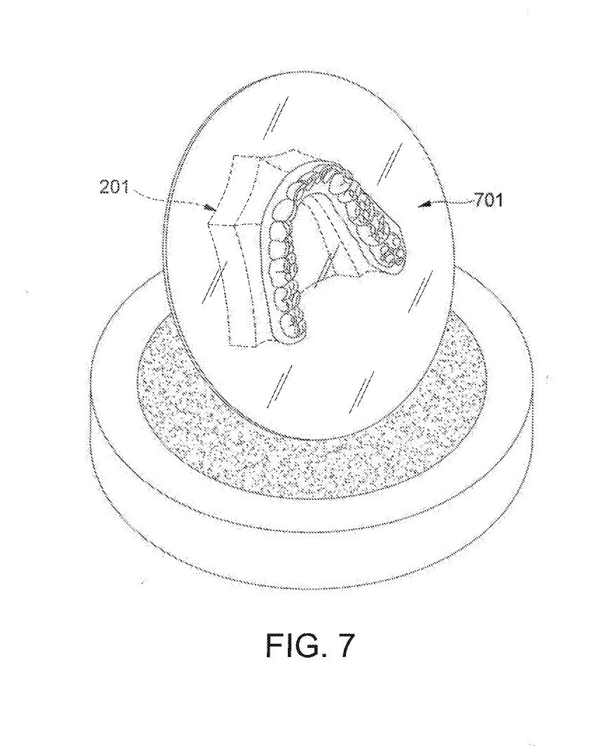

With reference to FIG. 5, the mold 201 generated from the impression 100 of the patient's teeth is placed in the aperture 305 in granules 501. Note that using granules is optional. Granules are not needed in other methods in other embodiments of the present disclosure. Further, the thermoplastic sheet 401 is placed in the upper member 302 (FIG. 3) of the device 301 (FIG. 3). With reference to FIG. 6, the upper member 302 is closed upon the lower member 303, and the thermoplastic sheet 401 is heated and sucked over the mold 201 thereby creating a tray 701, which is shown in FIG. 7. The tray 701 has a negative impression of the mold 201.

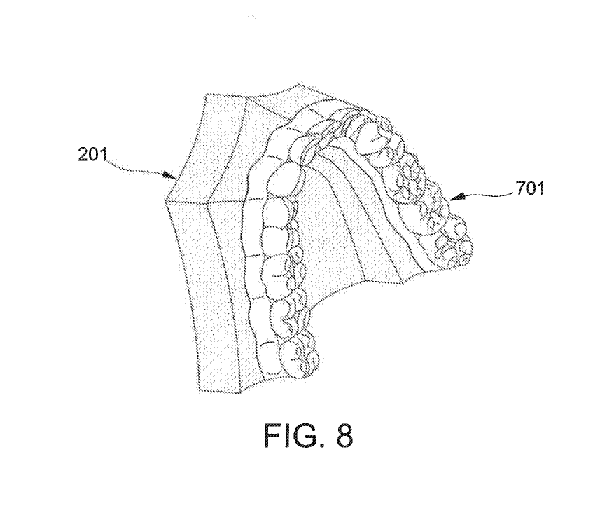

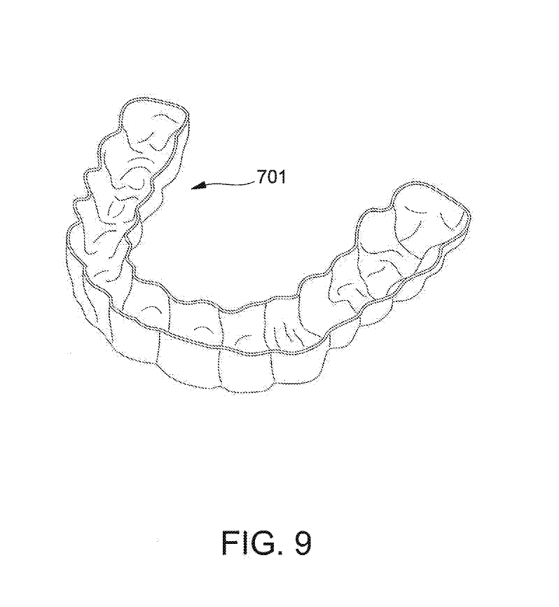

With reference to FIG. 8, excess sheet material is trimmed from the perimeter of the tray 701. Once the excess has been removed what is left is a tray 901 as depicted in FIG. 9.

This is the process for making a tray 901 in accordance with an embodiment of the present disclosure. Note that the present disclosure further encompasses the making of trays using other methods in other embodiments. The process described with reference to FIGS. 3-8 is merely for exemplary purposes only.

In the embodiments described hereinafter, other embodiments of the thermoplastic sheet 401 are contemplated. In the embodiments shown, the sheets 401 are at a minimal made of a dissolvable material, such as, for example, methylcellulose, propylene glycol, and Xanthan gum, which readily dissolve in saliva. This may be, for example, the base mixture. Note that contemplated with these further described embodiments is a manufacturing process as described with respect to FIGS. 3-8.

FIGS. 3-8 describe a process for making a mouth appliance tray in accordance with one embodiment of the present disclosure. However, other methods may be used to make the mouth appliance tray. For example, once a mold of the patient's teeth, gingival tissue, and soft tissue is created, the mold may be submerged in particular substances, lifted from the liquid or semi-liquid substances, and left to dry and harden. The mouth appliance tray may then be created by trimming away the excess hardened material. Types of liquid or semi-liquid substances that may be employed in this method include sodium alginate and/or calcium alginate.

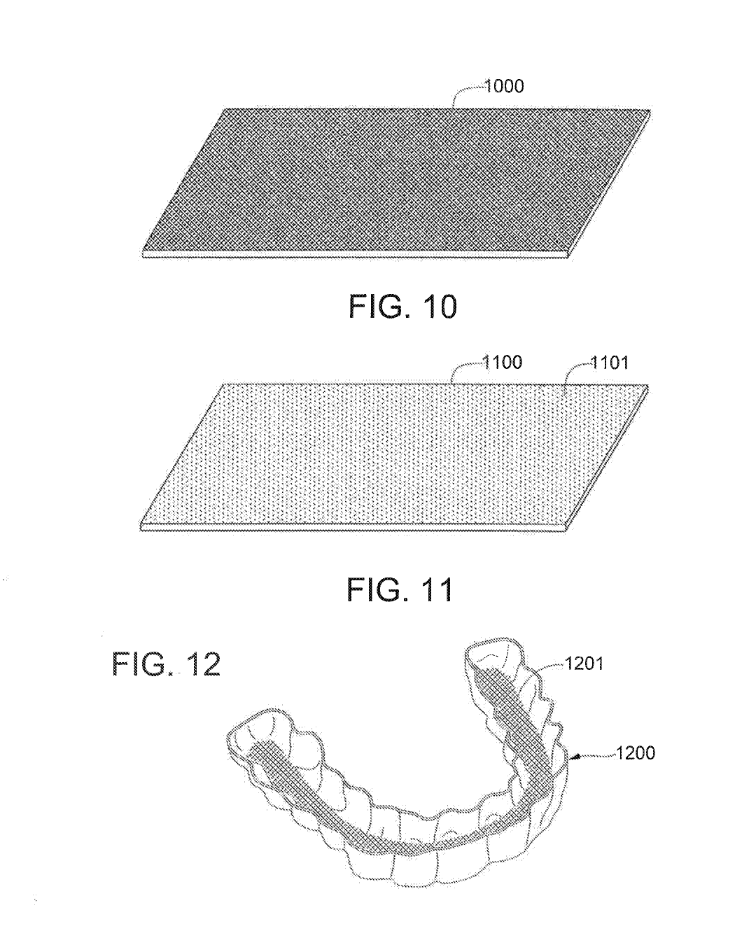

FIG. 10 depicts an exemplary sheet 1000 in accordance with an embodiment of the present disclosure. The sheet 1000 is a single layer and is made from a substance that readily dissolves in saliva, e.g., methylcellulose, polyethylene glycol, and Xanthan gum. This may be a base mixture. Additionally, the sheet 1000 comprises another dissolving substance 1001, e.g., pigments, flavor, or medication. Notably, molecules of the other substance 1001 may be injected into the dissolving sheet 1000 or formed within the sheet 1000 during other processes described further herein, and as the sheet 1000 dissolves, the molecules of the other substance 1001 dissolves as well, and is delivered to saliva of a patient who is wearing a tray appliance made from the sheet 1000.

As indicated hereinabove, the substance 1001 injected into the sheet 1000 may be, for example, medication, flavoring, vitamins, fluoride, pigments or a pH stabilizer. The sheet 1000 is then used in the process described hereinabove with reference to FIGS. 3-8 to make a mouth tray appliance 901. Thus, the tray 901 comprises both the components of the dissolvable sheet 1000, i.e., methylcellulose, polyethylene glycol, and Xanthan gum, the base mixture, and the dissolvable substance 1001.

When the patient (not shown) wears or otherwise places the tray 901 over his/her teeth, gingival tissue, or other soft tissue, the tray begins to dissolve. As the tray appliance 901 is dissolving, the substance 1001 is released from the dissolving tray 901 and enters the patient's system through natural bodily fluids (i.e., saliva).

Note that in the case where the sheet 1000 is made of pigments and/or flavoring, a resulting tray appliance 901 may be used for entertainment purposes. For example, the tray appliance 901 may be pigmented with collegiate team colors, e.g., red and white, that can be worn on game day. As the day goes on, the tray 901 dissolves, and the pigments run creating game day entertainment. Notably, the tray appliance 901 may comprise two components, pigment and flavoring, and as the tray appliance dissolves, both components are delivered to the saliva of the person wearing the tray appliance 901.

FIGS. 11 and 12 depict another embodiment of the present disclosure. The sheet 1100 in FIG. 11 comprises a plurality of pores 1101 that provide a channel through the sheet 1100. In such an embodiment, a tray 1200 shown in FIG. 12 is created using the pored sheet 1100 so that the tray 1200 (FIG. 11) comprises pores 1101. Note that pores 1101 are only shown in regards to one tooth impression; however in one embodiment pores 1101 are formed in the entirety of the tray 1200.

With reference to FIG. 12, a mesh 1201 is situated within the tray 1200. The mesh 1201 may be made of a dissolvable material and contain medication, flavoring, vitamins, fluoride, or pH stabilizer. Note that the mesh may be made of a paper or thin absorbent material that is injected or otherwise contains a dissolvable substance as described.

In such an embodiment, the mesh 1201 is inserted in the tray 1200 and the tray 1200 is placed over the patient's teeth or otherwise worn by the patient. Throughout the day, the mesh 1201 releases the substance contained in the mesh 1201, which is transferred from the tray 901, through the pores 1101, to the patient's saliva.

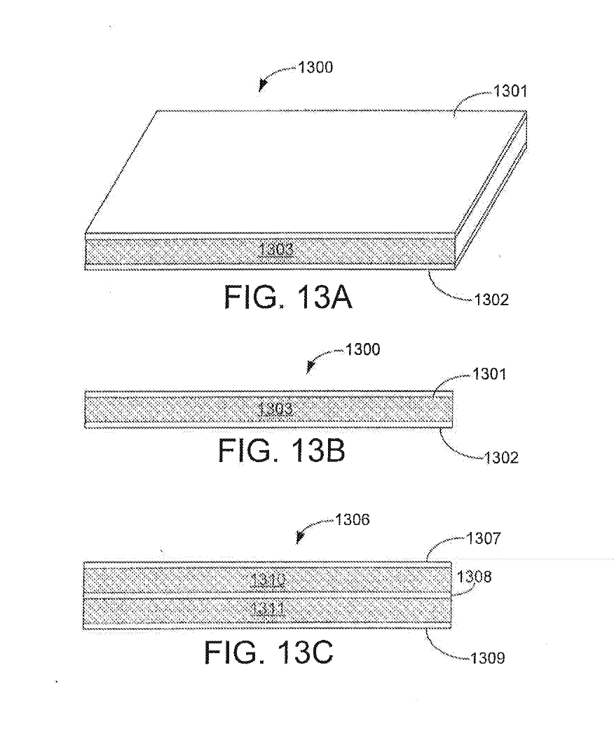

FIGS. 13A-13C depict another embodiment of the present disclosure wherein between dissolvable layers of sheets is a layer of dissolvable substance. As the sheets dissolve, the substance is released into the patient's saliva.

FIG. 13A depicts layered sheet 1300 comprising two dissolvable sheets 1302 and 1302, e.g., methylcellulose, polyethylene glycol, and Xanthan gum sheets. Between the sheets 1301 and 1302 is a dissolvable sheet 1303 comprised of a substance comprised of methylcellulose, polyethylene glycol, and Xanthan gum and another substance 1320 to be released into a patient's saliva as the sheet 1303 dissolves. The substance 1320 may include pigment, medication, flavoring, vitamins, fluoride, or pH stabilizer, chlorhexidine, whitening agents, over-the-counter drugs, prescription drugs, or a combination thereof as the substance 1320. In this regard, the substance 1320 may have two differing components, e.g., pigment/flavoring. In addition, the sheets 1301 and 1302 may be pigmented such that a tray made from the layered sheet is colored, e.g., in team colors to be worn on game day.

Further, FIG. 13B shows a cross-sectional view of the layered sheet 1300. Note that substance 1320 contained in sheet 1303 need not be evenly and uniformly injected into the sheet 1303. In this regard, if what is desired is delivery of the substance 1320 to a particular tooth or a chosen subset of a plurality of teeth, the substance 1320 may only be injected into the sheet 1303 at the location on the sheet that will ensure delivery of the substance 1320 to the tooth or chosen subset of the plurality of teeth. In addition, in the example where the substance 1320 is a pigment or a plurality of different pigments, the substance 1320 may be injected at locations on the sheet 1303 that ensure spatial separation of the different pigments when the tray appliance 901 made from the sheet 1300 is worn by a user. For example, every other tooth impression may exhibit a different pigment.

FIG. 13C shows a layered sheet 1306 comprising three sheets 1307, 1308 and 1309. Between sheets 1307 and 1308 is a sheet 1310 with a dissolvable substance 1330, and between layers 1308 and 1309 is a sheet 1311 with a dissolvable substance 1340. Note that the dissolvable substances may comprise a plurality of dissolvable components, e.g., one or more of pigment, medication, flavoring, vitamins, fluoride, pH stabilizer, chlorhexidine, whitening agents, over-the-counter drugs, and prescription drugs. In such an embodiment, a tray appliance 901 is made by the method described hereinabove with respect to FIGS. 1 through 9 using the layered sheets 1300 or 1306 or methods described further herein.

When made with the layered sheet 1306, the tray appliance 901 has an external layer of dissolvable substance 1330 and an internal dissolvable substance 1340. The tray appliance 901 created with the layered sheet 1306 is placed over the patient's teeth (not shown) or otherwise inserted in the patient's mouth (not shown). The tray appliance may be formed such that the sheet 1309 dissolves first, which exposes the external layer sheet 1311 and dissolvable substance 1340. Thus, the dissolvable substance 1340 is initially released into the patient's saliva (not shown). Sheet 1308 then dissolves as time progresses. As sheet 1308 dissolves, the dissolvable sheet 1310 and substance 1330 dissolve and the substance 1330 is released into the patient's saliva. Thereafter, sheet 1307 dissolves.

In the embodiment depicted and described with reference to FIG. 13C, dissolvable substances 1340 and 1330 may be placed in an order according to when contained medicine is to be released in the patient's saliva. For example, if the dissolvable substance 1340 is to be provided to the patient prior to dissolvable substance 1330, then the tray appliance 901 is created so that the dissolvable substance 1340 is contained between layers 1309 and 1308, and layer 1311 is exposed through layer 1309 to the patients mouth, whereas layer 1310 is close to the patients teeth, gingival tissues, or soft tissue Thus, the substance 1330 will be dissolved and delivered to the patient's mouth after substance 1340. Note that each substance 1330 and 1340 may comprise one or more dissolvable components, e.g., flavoring/medication.

In one embodiment, the sheets 1311 and 1310 may have different dissolve rates. For example, sheet 1311 may dissolve in a 24-hour period, whereas sheet 1310 may dissolve in a 72-hour period. This may likely be necessitated by prescription characteristics of the dissolvable substances 1330, 1340. The varying dissolve rates may be formed by changing the material making up the sheets 1311, 1310, respectively. For example, the thickness of the sheets 1311 and 1310 may be made such that if longer dissolve rates are needed, the sheets 1311 and 1310 are made thicker, and if shorter dissolve rates are needed, the sheets 1310 and 1311 are made thinner. Thus, the width of the sheets 1311 and 1310 can dictate the rate at which substances or components of substances are delivered to saliva of the mouth of a person wearing a tray appliance 901 made from the sheet 1306.

Note that the present disclosure shows a single sheet of methylcellulose, propylene glycol, and Xanthan gum in FIGS. 10 and 11. Further note that FIGS. 13A and 13C show more than one sheet of methylcellulose, propyl glycol, and xanthan gum. The present disclosure is not limited to one sheet, three melded sheets, or even five melded sheets. In this regard, any number of methylcellulose, propyl glycol, and Xanthan sheets may be melded together to form different embodiments of the present disclosure.

In one embodiment of the present disclosure, a single methylcellulose, propylene glycol, and Xanthan sheet may contain two different substances A and B, e.g., two different prescription medications. In such an embodiment, the delivery rate of each substance may be manipulated based on the ratio of the two substances on to the other. For example, prior to gelling the solution as described hereinabove, the two substances are mixed into the solution, the solutions is then boiled, and allowed to gel. Thus, the sheet formed from such a process would contain at least two deliver substances. If substance A is to be delivered at a higher rate than substance B, the density of substance A would be greater than that of substance B in the sheet. As a tray appliance made with such a sheet dissolves in a patient's mouth, due to the higher density of substance A, A would be delivered to the patient's body at a higher rate than that of substance B.

Likewise, the thickness of a sheet may be manipulated to increase or lower delivery rates of substances. For example, a first sheet may contain a particular amount of substance A suspended throughout, and the delivery rate is governed by the amount of substance per volume of a mouth appliance tray. In order to increase the delivery rate, the same amount of A may be suspended in a sheet that is thinner, which would increase the delivery rate, i.e., more A per volume, of a mouth appliance tray made with such a sheet. Whereas if the same amount of A were suspended in a sheet that had a greater thickness, the delivery rate would decrease, i.e., less A per volume, of a mouth appliance tray made with such a sheet.

There are numerous ways in which the thermoplastic sheets shown in FIG. 4-13C may be manufactured. In one embodiment, experimental processes have shown the following equipment may be utilized in the manufacturing process:
Heating Source: Fisher Scientific-Fisher Stirring Hotplate (2);
Pyrex beakers in a variety of sizes: 100 mL and 200 mL;
Pyrex graduated cylinders;
Refrigerator;
Lab stirring apparatus: metal/glass stirring rods;
Magnetic stir rod;
Analytical balance/scale;
MiniStart Vacuum Form;
Stanley Air Compressor;
Cutting board and cutting blade;
16×12×1 inch Wilton Baking Pan Convection Oven;
Weigh boats;
Heat resistant gloves;
Thermometer, and
Desiccator and desiccants.

Further, the following process is contemplated for the manufacturing of the exemplary trays shown in FIGS. 4 and 13C. As a precursor, a recommended batch size may be 800 mL, including 24 g of Methylcellulose (HV); 0.8 g of Xanthan Gum; and 80 mL Propylene Glycol

By using the Pyrex graduated cylinder, the process may use 800 mL of distilled water, which is poured into a 1000 mL or larger Pyrex beaker. Once poured in the Pyrex beaker to measure, placing a large magnetic stir rod in the distilled water beaker and began to heat the water gently to 70° C. with constant stirring on a Fisher Scientific-Fisher Stirring Hotplate (heat dial setting is in a range from 8-9).

Next, the process comprises weighing out 24 g of Methylcellulose (HV) and 0.8 g of Xanthan Gum in a weigh boat (not shown) on an analytical balance/scale. The process further comprises removing the weigh boat from the balance and mixing the materials together to make a uniform powder mixture utilizing a metal/glass stirring apparatus.

Further, the process comprises add powder mixture to 80 mL of Propylene Glycol in a separate Pyrex beaker and stir manually, using a metal/glass stirring apparatus, for 2-3 minutes to mix all powders. Note that the solution will become may become viscous and the powders may seem to clump, regardless, the process contemplates continuing mixing to ensure all powder particles have interacted with the Propylene Glycol.

In the process, the next step is checking the distilled water temperature with a thermometer to see if the water is 70° C. Note that if the temperature has failed to reach 70° C., the process comprises increasing the heat dial setting. Once the temperature has reached 70° C., the process comprises adding the PG/powder solution to the distilled water via a metal/glass stirring apparatus and increasing temperature to 90° C. or until solution boils. For later use, the process may comprise recording the time the solutions are combined.

As soon as the solution begins to boil, the process comprises removing the beaker from the heating source using heat resistant gloves and placing the beaker on another Fisher Scientific-Fisher Stirring Hotplate without heat. Further, the process comprises allowing powders to hydrate under constant magnetic bar stirring (stirring dial setting of 6) for approximately 1 hour or until the solution reaches 40° C. For later use, the process may require recording the temperature of solution and time the solution was removed from the heating source

Once the solution has cooled to 40° C., the process comprises pouring the solution directly from the Pyrex beaker in a 16×12×1 inch Wilton baking pan and labeling the pan-listing formulation and date. The process further comprises ensuring gel is evenly distributed in the pan and popping bubbles from the gel using the cake baking technique. Next, the process comprises refrigerating the gel in the pan for 30 minutes at 1° C. Note that the plated solution will appear cloudy/clear-white at 40° C. For later use, the process may require recording the length of time hydrated.

The process further comprises removing the plated solution from refrigeration and allowing the gel to rest on the benchtop overnight uncovered. Note that the gels should rest for 16-18 hours and should appear uniform and clear. For later use, the process further comprises recording the time removed from refrigeration and humidity/temperature of lab space.

The process further comprises utilizing a convection oven to dry gels at 170° C. for approximately 2 hours or until gel is evenly dry on both sides. Note that the gel may form a dry top layer, but may need to be flipped to dry the other side of the gel.

Once dry, the process comprises removing the gel from the oven with heat resistant gloves and allowing it to cool to room temperature. Additionally, the process comprises slowly peeling the film from the baking sheet, placing the film on a cutting board, and cutting film to fit vacuum form heating unit, 125 mm in diameter. In one embodiment, a cutting blade/cookie cutter can be used for the trimming. The process further comprises testing the film on the vacuum form via the following settings: 20 seconds of heating and 45 seconds of vacuuming. Finally, the process comprises removing the film from the model without inverting the film. Note that if the film will not be used immediately, place film in a desiccator until desired time of use.

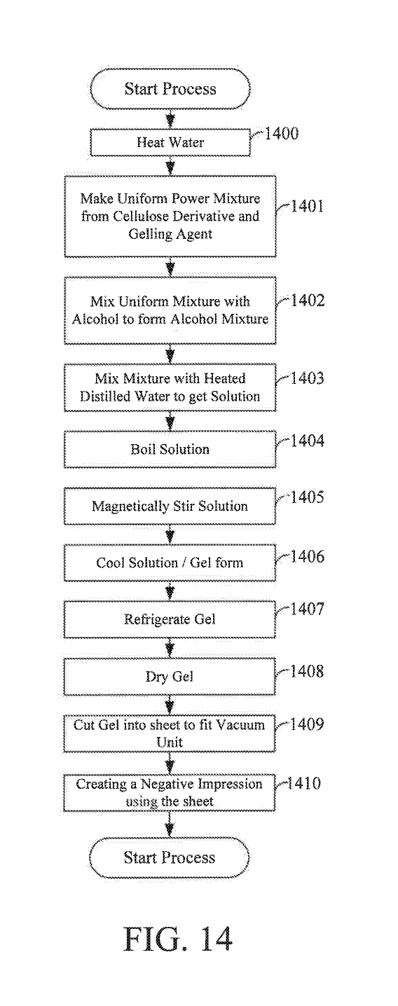

The functionality of a process is now described with reference to FIG. 14 in accordance with an embodiment of the present disclosure.

In step 1402, water is heated. Simultaneous therewith in step 1401, a uniform power mixture is made by mixing a cellulose derivative and a gelling agent. Note that any type of cellulose derivative may be used in other embodiments, and a cellulose derivative has the molecular structure of (C₆H₁₀O₅)ₙ, where n can represent a linear chain of several hundred to many thousands of linked D-glucose units. Further note that any type of gelling agent may be used in other embodiments. Examples of gelling agents include acacia, alginic acid, bentonite, Carbopols®, carbozymethyl cellulose, ethylcellulose, gelatin, hydroxyethyl cellulose, hydroxypropyl cellulose, magnesium aluminum silicate, poloxamers, polyvinyl alcohol, sodium alginate, tragacanth, and xanthan gum.

In step 1403, the uniform mixture is mixed with alcohol to form an alcohol mixture. Any type of alcohol may be used in other embodiment of the present enclosure. An alcohol is an organic compound where a hydroxyl unit (—OH) is bound to a saturated carbon atom. In step 1403, the alcohol mixture is mixed with distilled water to get a solution, and in step 1404, the solution is boiled.

In one embodiment, the solution is magnetically stirred, in step 1405. Note that in one embodiment while the solution is cooling, the solution can be magnetically stirred with allowing solution to hydrate for about one (1) hour.

In step 1406, the solution is allowed to cool and it forms a gel in step 1406. In step 1407, the gel is refrigerated. Note that in on embodiment, the gel is rested for 16-18 hours at which time it appears uniform and clear. In step 1408, the gel is dried. In one embodiment, use of a convection oven may be made, and the gel may be dried at 170° C. for approximately two (2) hours or until gel is evenly dry on both sides. Note that the gel may form a dry top layer, but may be flipped to dry the other side of the gel.

In step 1409, the gel is peeled from a backing sheet and cut into sheets like those shown in FIG. 4 and FIGS. 10-13C. The size of the sheets depends upon the vacuum form heating unit used for creating the mouth trays from the sheets. In step 1410, the sheet is placed on a teeth mold, and trays exhibiting the characteristics of the sheets described with reference to FIG. 4 and FIG. 10-13C may be made.

Above is described a detailed process for manufacturing sheets in accordance with an embodiment of the present disclosure. Note that sheets contemplated by FIGS. 10 and 11 may be created by having an injection step when the gel is being formed. In this regard, the process would include mixing in a substance with the solution before a gel is formed. In this regard, different colors of dental trays are made wherein a pigment is mixed with the solution before the gel is formed. Likewise, a flavoring component or a medication may also be mixed into the solution before the gel is made. Notably, in use, as the sheet 1000 (FIG. 10) dissolves, the molecules of the other substance 1001 dissolves as well and are delivered to a wearer's saliva, which is visible in the wearer's mouth. This type of tray may be used, for example, to promote team spirit using a team's colors. Note that the color may be any color, including primary colors or any mixture there, or pastel colors, or any mixture thereof.

Note that in regards to FIG. 11 wherein the sheet comprises pore, the pores may be made in the sheet 1100 (FIG. 11). In one embodiment, the pores may be formed after the solution has gelled and cooled by using a sharp instrument and applying the sharp instrument to the sheet 1100. The sharp instrument may have one pointed component or many pointed components for making the pores.

The layered sheet 1300 (FIG. 13A) may be manufactured by manufacturing two sheets with no differing characteristics, 1301 and 1302 (FIG. 13A) as described hereinabove. The sheets 1301 and 1302 may then be melded on each side of a sheet that comprises an injected substance. This may be effectuated through aligning the three (3) sheets 1301, 1303, and 1302, and applying a heating method. Such a substance may include pigment, medication, flavoring, vitamins, fluoride, or pH stabilizer.

The layered sheet 1306 may be manufactured by manufacturing separately three sheets 1307, 1308 and 1309 (FIG. 13C). Between sheets 1307 and 1308 is a sheet 1310 that may be manufactured with a dissolvable substance 1330, and between 1308 and 1309 is a sheet 1311 with a dissolvable substance 1340. In such an embodiment tray may be made by the method described hereinabove with respect to FIGS. 1 through 9 to create the separate sheets 1307, 1310, 1308, 1311, and 1309, wherein 1310 and 1311 are injected during the process with a substance, e.g., pigment, medication, flavoring, vitamins, fluoride, pH stabilizer, chlorhexidine, whitening agents, over-the-counter drug, prescription drug, sublingual medication, or a combination thereof.

In another embodiment, the layered sheet 1306 may be manufactured by making the separate sheets 1307, 1310, 1308, 1311, and 1309, wherein 1310 and 1311 are made with one or a plurality of substances. Once the separate sheets are made, the sheets are stacked, melded together (e.g., with hydration or heating). The separate sheets needed to form a mouth appliance tray like that shown in FIG. 13C could be created by cutting a piece from the stack, wherein the piece would have a layer of each of the sheets 1307, 1310, 1308, 1311, and 1309. The sheet could then be used in a vacuum heater or a 3D printer to create a mouth appliance sheet in accordance with an embodiment of the present disclosure.

What is claimed is:

1. A tray appliance, comprising:
a first dissolvable sheet;
a first substance formed within a second dissolvable sheet, the first dissolvable sheet laid on the second dissolvable sheet and being formed into a first dissolvable negative impression of a person's teeth, gingival tissue, or other soft tissue, such that when first dissolvable negative impression is worn by a person, the first dissolvable negative impression dissolves and releases the first substance into the person's saliva, teeth, gingival tissue, or other soft tissue.

2. The tray appliance of claim 1, wherein the first substance is selected from a list comprising pigment, medication, flavoring, vitamins, fluoride, pH stabilizer, chlorhexidine, whitening agents, over-the-counter drug, prescription drug, sublingual medication, or a combination thereof.

3. The tray appliance of claim 2, wherein the pigment is added to provide a specific color to complete or portions of the first dissolvable negative impression.

4. The tray appliance of claim 1, wherein the first sheet is comprised of a mixture of cellulose and a gelling agent to form the first dissolvable sheet.

5. The tray appliance of claim 1, further comprising a third dissolvable sheet, wherein neither of the first dissolvable sheet and third dissolvable sheet contain a first substance, and wherein the second dissolvable sheet is laid on the first dissolvable sheet, and the second and first dissolvable sheets are laid on the third dissolvable sheet forming a layered sheet, and the first dissolvable negative impression is created from the layered sheet.

6. The tray appliance of claim 1, further comprising a third dissolvable sheet, a fourth dissolvable sheet, and a fifth dissolvable sheet wherein none of the first dissolvable sheet, the third dissolvable sheet, or the fifth dissolvable sheet contain first substances, and wherein the second dissolvable sheet is laid on the first dissolvable sheet, the second dissolvable sheet and the first dissolvable sheet are laid on the third dissolvable sheet, the second dissolvable sheet, the first dissolvable sheet, and the third dissolvable sheet are laid on the fourth dissolvable sheet, and the second dissolvable sheet, the first dissolvable sheet, the third dissolvable sheet, and the fourth dissolvable sheet are laid on the fifth dissolvable sheet thereby creating a layered sheet, and the first dissolvable negative impression is formed from the layered sheet.

7. The tray appliance of claim 1, further comprising a third dissolvable sheet comprising a second substance, wherein the first dissolvable sheet is laid on the third dissolvable sheet creating a layered sheet, and the first dissolvable negative impression is formed from the layered sheet, such that when the first dissolvable negative impression is placed in the person's mouth, the first substance is delivered to the person's body, and after the first substance is delivered to the person's body, the second substance is delivered to the person's body.

8. The tray appliance of claim 1, wherein the first substance has a dissolve rate defined by a ratio of an amount of material forming the first dissolvable sheet to the amount of the first substance.

9. The tray appliance of claim 1, wherein the first substance has a dissolve rate defined by a ratio of an amount of material forming the second dissolvable sheet to the amount of the first substance.

10. The tray appliance of claim 1, further comprising a third dissolvable sheet and a second substance formed within the third dissolvable sheet, wherein the first substance has a dissolve rate defined by an amount of material forming the first dissolvable sheet to an amount of the first substance, and the second substance has a dissolve rate defined by an amount of material forming the second dissolvable sheet to an amount of the second substance.

11. The tray appliance of claim 1, wherein a dissolve rate of the first substance is determined by a thickness of the first dissolvable sheet.

12. The tray appliance of claim 1, wherein the first negative impression is created by scanning the person's mouth, determining the shape of the first dissolvable negative impression, and printing the first dissolvable negative impression on a three-dimensional printer.

13. A tray appliance, comprising:
a first substance configured for delivery to a person's body;
a second substance comprising a base mixture configured for mixing with the first substance making a first dissolvable sheet; and
the first substance and the second substance mixed together to form the first dissolvable sheet, the first dissolvable sheet formed into a first dissolvable negative impression of a person's teeth, gingival tissue, or other soft tissue such that when the first dissolvable negative impression is worn by a person, the first substance and the second substance dissolve in the person's body.

14. The tray appliance of claim 13, wherein the first substance is selected from a list comprising pigment, medication, flavoring, vitamins, fluoride, pH stabilizer, chlorhexidine, whitening agents, over-the-counter drug, prescription drug, sublingual medication, or a combination thereof.

15. The tray appliance of claim 14, wherein the pigment is added to provide a specific color to complete or portions of the first dissolvable negative impression.

16. The tray appliance of claim 13, wherein the second substance is a mixture of cellulose and a gelling agent.

17. The tray appliance of claim 13, further comprising a second dissolvable sheet and a third dissolvable sheet, wherein neither the second dissolvable sheet and third dissolvable sheet comprise first substances and wherein the second dissolvable sheet is laid on the first dissolvable sheet, and the second dissolvable sheet and the first dissolvable sheet are laid on the third dissolvable sheet, thereby creating a layered sheet from which the negative dissolvable impression is formed.

18. The tray appliance of claim 13, further comprising a second dissolvable sheet, a third dissolvable sheet, a fourth dissolvable sheet, and a fifth dissolvable sheet wherein none of the second dissolvable sheet, the third dissolvable sheet, and the fifth dissolvable sheet contain first substances, and wherein the second dissolvable sheet is laid on the first dissolvable sheet, the second dissolvable sheet and the first dissolvable sheet are laid on the third dissolvable sheet, the second dissolvable sheet, the first dissolvable sheet, and the third dissolvable sheet are laid on the fourth dissolvable sheet, and the second dissolvable sheet, the first dissolvable sheet, the third dissolvable sheet, and the fourth dissolvable sheet are laid on the fifth dissolvable sheet thereby creating a layered sheet, and the first dissolvable negative impression is formed from the layered sheet.

19. The tray appliance of claim 13, wherein the dissolve rate of the first substance is determined by a ratio of an amount of material making up the first dissolvable sheet to an amount of the first substance.

20. The tray appliance of claim 13, further comprising a third substance formed within a second dissolvable sheet and wherein the dissolve rate of the first substance and the third substance is determined by a thickness of the first dissolvable sheet and a thickness of the second dissolvable sheet, respectively.

21. The tray appliance of claim 13, wherein the first substance comprises a mixture of two different components.

22. The tray appliance of claim 21, wherein the ratio of an amount of each of the two different components to an amount of material of the second substance is such that their delivery rates to the person's body differ.
